(19) United States
(12) Patent Application Publication
(10) Pub. No.: US 2026/0162546 A1
(43) Pub. Date: Jun. 11, 2026

(54) SYSTEM AND METHOD FOR ASSISTING THE LANDING OF AN AIRCRAFT AT AN AIRPORT

(71) Applicants: Airbus (S.A.S.), Blagnac Cedex (FR); Airbus Operations (S.A.S.), Toulouse (FR)

(72) Inventors: Pascal Laurens, Toulouse (FR); Jean-Baptiste Berthier, Toulouse (FR); Jonathan Rigaud, Toulouse (FR)

(73) Assignees: Airbus (S.A.S.), Blagnac (FR); Airbus Operations (S.A.S.), Toulouse (FR)

(21) Appl. No.: 19/409,957

(22) Filed: Dec. 5, 2025

(30) Foreign Application Priority Data
Dec. 11, 2024 (FR) FR2413825

(51) Int. Cl. G08G 5/80; G08G 5/265; G08G 5/54; G08G 5/76

(52) U.S. Cl. CPC G08G 5/80; G08G 5/265; G08G 5/54; G08G 5/76

(57) ABSTRACT

A system includes a flight management system and anticollision system installed on board an aircraft, and a transponder installed in a predefined position at an airport and linked to a computer of an air traffic control center. The transponder is configured to receive environmental information transmitted by the computer. The anticollision system is configured to interrogate the transponder, to receive, in response, the environmental information and to determine a position of the transponder. One of the anticollision system or the flight management system is configured to compare the position of the transponder determined by the anticollision system with a theoretical position saved on board the aircraft to authenticate the environmental information received only if the determined position corresponds to the theoretical position. The flight management system is configured to order an aircraft flight trajectory as a function of the environmental information received when it is authenticated.

### TECHNICAL FIELD

The disclosure herein relates to the field of assistance in the landing of an aircraft at an airport. In order to land an aircraft at an airport, a member of the crew of the aircraft needs to prepare an approach phase for the aircraft to approach a landing runway of the airport. To do this, the crew member must collect environmental information relating to the airport, in particular: meteorological information (temperature, wind, etc.), information relating to at least one landing runway of the airport (runway open or closed, presence of obstacles, direction for landing on the runway, active heading of the runway, etc.) and/or other information relating to the airport. In practice, to obtain this information, the crew member communicates by voice with an air traffic control center of the airport. On the basis of the information obtained, the crew member selects a landing runway and a procedure for approaching the landing runway. A pilot of the aircraft then orders a trajectory of the aircraft that allows this approach procedure to be followed.

### BACKGROUND

In order to reduce the workload of the crew members of the aircraft, it would be desirable to automatically prepare the approach phase for the aircraft to approach a landing runway of the airport. However, this makes it necessary to have available the abovementioned environmental information relating to the airport. There is therefore a need to allow the aircraft to automatically acquire this environmental information in a sufficiently reliable and secure manner. In particular, in order to avoid any risk of malicious intent, it is necessary to guarantee that the aircraft acquires this environmental information solely from a air traffic control center of the airport.

### SUMMARY

The object of the disclosure herein is in particular to provide a solution to this problem. It relates to a system for assisting the landing of an aircraft at an airport, the landing assistance system comprising an aircraft flight management system and a TCAS-type anticollision system which are both installed on board the aircraft.

The landing assistance system is noteworthy in that it additionally comprises a transponder installed in a predefined position at the airport, the transponder being linked to a computer of an air traffic control center of the airport, and in that:
the transponder is configured to receive and save, in a memory, environmental information transmitted by the computer of the air traffic control center of the airport;
the TCAS-type anticollision system is configured to interrogate the transponder and to receive, in response, the environmental information saved in the memory of the transponder, and to determine a position of the transponder;
at least one of the TCAS-type anticollision system or the aircraft flight management system is configured to compare the position of the transponder determined by the TCAS-type anticollision system with a theoretical position of the transponder saved in a database on board the aircraft so as to determine whether the position of the transponder determined by the TCAS-type anticollision system corresponds to the theoretical position of the transponder and to authenticate the environmental information received from the transponder only if the position of the transponder determined by the TCAS-type anticollision system corresponds to the theoretical position of the transponder; and
the flight management system is configured in such a way that, in the event that the environmental information received from the transponder is authenticated, the flight management system orders an aircraft flight trajectory as a function of at least the environmental information.

The landing assistance system according to the disclosure herein makes it possible to verify whether the environmental information received by the aircraft originates from a transponder situated in a position that corresponds to a stored theoretical position associated with an air traffic control center of the airport at which the aircraft must land and, in such a case, to authenticate the environmental information received by the aircraft. It is deemed that the theoretical position of the transponder stored in the database corresponds to a secure area to which a person with malicious intent could not have access. Consequently, environmental information that might be sent at the instigation of a person with malicious intent would not be authenticated by the landing assistance system according to the disclosure herein, since the position of the transponder then would not correspond to the stored theoretical position associated with the air traffic control center. This makes it possible to guarantee the security of an approach by the aircraft, to the landing runway of the airport, performed on the basis of environmental information received by the aircraft by the landing assistance system according to the disclosure herein.

In one embodiment, the environmental information comprises at least one subset of the following environmental information:
meteorological information;
information relating to a landing runway of the airport;
information relating to the airport.

In one embodiment, the transponder is linked to the computer of the air traffic control center of the airport via a communication link which is independent of a public communication network.

The disclosure herein also relates to an aircraft having a system for assisting landing at an airport, the landing assistance system comprising an aircraft flight management system and a TCAS-type anticollision system. The aircraft is noteworthy in that:
the TCAS-type anticollision system is configured to:
   interrogate a transponder installed in a predefined position at the airport, the transponder being linked to a computer of an air traffic control center of the airport and being configured to receive and save, in a memory, environmental information transmitted by the computer of the air traffic control center of the airport;
   receive, in response, the environmental information saved in the memory of the transponder; and
   determine a position of the transponder,
at least one of the TCAS-type anticollision system or the aircraft flight management system is configured to compare the position of the transponder determined by the TCAS-type anticollision system with a theoretical position of the transponder saved in a database on board the aircraft so as to determine whether the position of the transponder determined by the TCAS-type anticollision system corresponds to the theoretical position of the transponder and to authenticate the environmental information received from the transponder only if the position of the transponder determined by the TCAS-type anticollision system corresponds to the theoretical position of the transponder; and
the flight management system is configured in such a way that, in the event that the environmental information received from the transponder is authenticated, the flight management system orders an aircraft flight trajectory as a function of at least the environmental information.

The disclosure herein also relates to a method for assisting the landing of an aircraft at an airport,
the aircraft comprising a flight management system and a TCAS-type anticollision system which are installed on board the aircraft,
a transponder being installed in a predefined position at the airport, the transponder being linked to a computer of an air traffic control center of the airport.

The method is noteworthy in that it comprises the following steps:
a step implemented by the computer of the air traffic control center of the airport, consisting in transmitting environmental information, relating to the airport, to the transponder;
a step implemented by the transponder consisting in receiving the environmental information and in saving it in a memory;
a step implemented by the TCAS-type anticollision system consisting in interrogating the transponder, in receiving, in response, the environmental information saved in the memory of the transponder, and in determining a position of the transponder;
a step implemented by at least one of the TCAS-type anticollision system or the aircraft flight management system, consisting in comparing the position of the transponder determined by the TCAS-type anticollision system with a theoretical position of the transponder saved in a database on board the aircraft so as to determine whether the position of the transponder determined by the TCAS-type anticollision system corresponds to the theoretical position of the transponder and in authenticating the environmental information received from the transponder only if the position of the transponder determined by the TCAS-type anticollision system corresponds to the theoretical position of the transponder; and
in the event that the environmental information received from the transponder is authenticated, a step implemented by the flight management system consisting in ordering an aircraft flight trajectory as a function of at least the environmental information.

### BRIEF DESCRIPTION OF THE DRAWINGS

The disclosure herein will be understood better upon reading the description that follows and upon examining the appended drawings.

FIG. 1 is a simplified view illustrating a system for assisting the landing of an aircraft at an airport, according to an embodiment of the disclosure herein.

FIG. 2 illustrates an aircraft equipped with a system for assisting landing at an airport, according to an embodiment of the disclosure herein.

FIG. 3 schematically illustrates the system for assisting the landing of an aircraft at an airport of FIG. 1.

FIG. 4 illustrates a method for assisting the landing of an aircraft at an airport, according to an embodiment of the disclosure herein.

### DETAILED DESCRIPTION

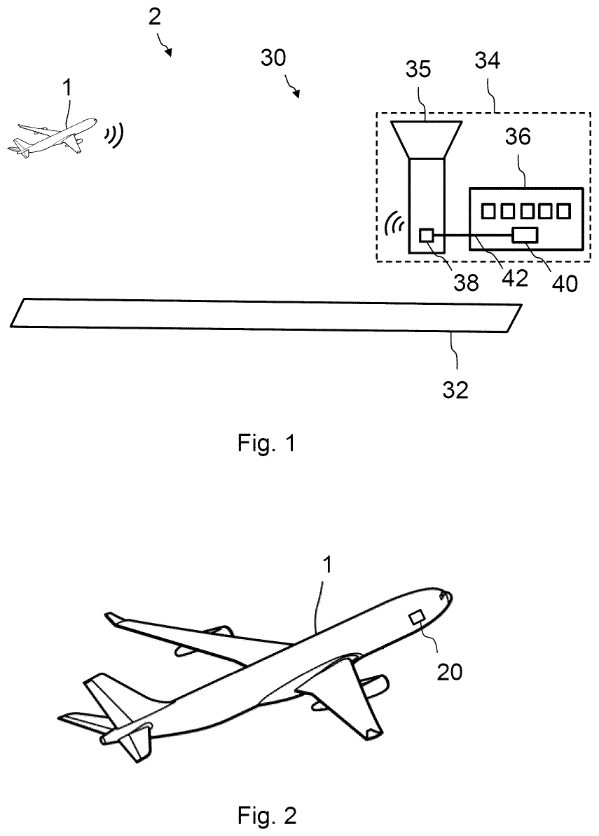

The landing assistance system 2 illustrated in FIG. 1 comprises an airport 30 and an aircraft 1. The airport 30 comprises at least one landing runway 32, and an air traffic control center 34. A transponder 38 is installed in a predefined position at the airport, for example in a control tower 35 of the air traffic control center. The transponder 38 is linked to a computer 40 of the air traffic control center 34. The computer 40 is installed in a building 36 of the air traffic control center, for example, this building 36 possibly being separate from the control tower 35 or combined with the latter. Other locations of the transponder 38 at the airport are possible without departing from the scope of the disclosure herein, provided that the predefined position of the transponder corresponds to a location that is inaccessible to an unauthorized person. The transponder 38 is linked to the computer 40 via a communication link 42 which is independent of a public communication network such as, in particular, the Internet. The transponder 38 is intended to communicate with a TCAS-type anticollision system 20 with which the aircraft 1 is equipped, as illustrated in FIG. 2.

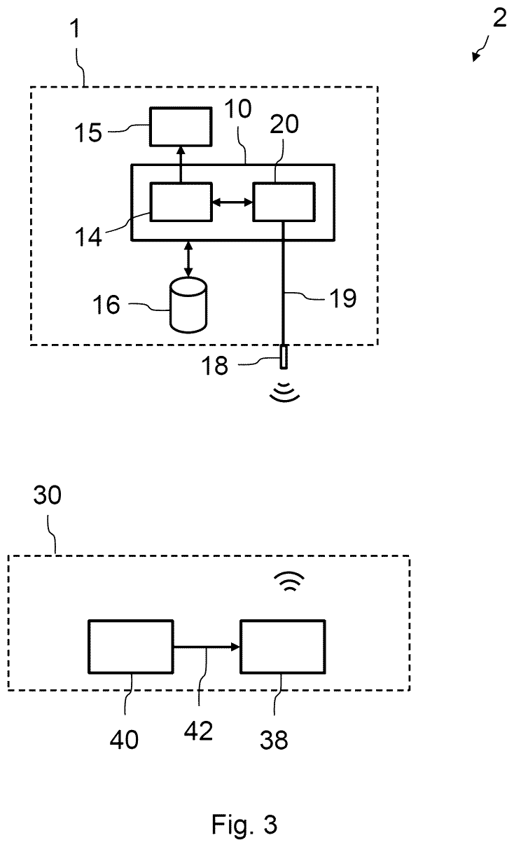

As illustrated in FIG. 3, the aircraft 1 comprises a landing assistance system 10. This landing assistance system includes a flight management system (FMS) 14, and the TCAS-type anticollision system 20. The landing assistance system 10 is linked to a database 16 installed on board the aircraft, this database containing at least addresses of transponders at different airports. According to a first alternative, the database 16 additionally contains values of theoretical positions associated with each of the transponders. According to a second alternative, the landing assistance system 10 is additionally linked to another database 16′ (not shown in the figure) containing the values of theoretical positions. Without departing from the scope of the disclosure herein, the database 16 (respectively 16′) may correspond to a memory of an avionics computer with which the aircraft 1 is equipped. The TCAS-type anticollision system 20 is linked to an antenna 18 of the aircraft via a link 19. Advantageously, the flight management system 14 is linked to an aircraft guidance system 15 of the FG (“Flight Guidance”) type, for example.

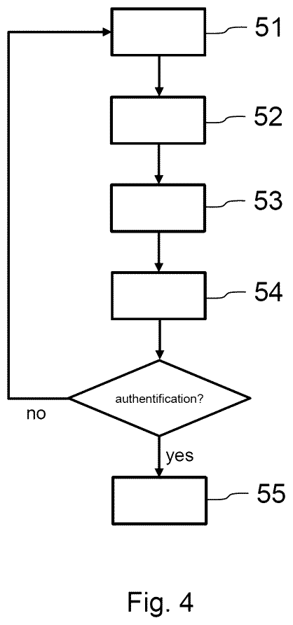

In operation, in a step 51 as illustrated in FIG. 4, the computer 40 of the air traffic control center 34 transmits environmental information, relating to the airport 30, to the transponder 38 via the link 42. In particular, this environmental information comprises at least one item from among the following information: the “open” or “closed” status of the landing runway 32, the presence of obstacles on the landing runway, the condition of the landing runway (dry, wet, presence of snow or ice, etc.), the direction for landing on the landing runway (an active heading, for example), meteorological information (temperature, wind etc. at the airport), information relating to the airport (for example the name of the airport as defined in nomenclature managed by the International Civil Aviation Organization).

In a step 52, the transponder 38 receives the environmental information transmitted by the computer 40.

The two steps 51 and 52 may be implemented asynchronously in relation to the following steps.

In a step 53, the TCAS-type anticollision system 20 interrogates the transponder 38 of the airport 30. In an exemplary embodiment, the flight management system 14 identifies the airport 30 as the destination airport provided in a current aircraft flight plan. The flight management system acquires, from the database 16, the address of the transponder 38 corresponding to the airport 30 and it sends a request to the TCAS-type anticollision system to ask it to interrogate this transponder. After interrogation of the transponder 38, the TCAS-type anticollision system receives, in response, the environmental information relating to the airport 30 and it determines a theoretical position of the transponder 38 in the usual manner, in the same way as it is able to determine the position of a transponder installed on board another aircraft.

A following step 54 is implemented by one of the TCAS-type anticollision system or the flight management system 14. When this step is implemented by the flight management system, the TCAS-type anticollision system transmits to the flight management system 14, in advance, the environmental information received from the transponder 38 and also the position of the transponder that it has determined. This step 54 consists in acquiring a theoretical position of the transponder 38 saved in the database 16 or 16′ and in comparing the position of the transponder 38 determined by the TCAS-type anticollision system with this theoretical position so as to determine whether the position determined by the TCAS-type anticollision system corresponds to the theoretical position and in authenticating the environmental information received from the transponder only if the position determined by the TCAS-type anticollision system corresponds to the theoretical position of the transponder. In the event that a person with malicious intent were to try to send information to the aircraft by another transponder, this transponder could not be situated in the theoretical position of the transponder 38 corresponding to the airport because the person with malicious intent would not be able to access this position that corresponds to a location that is inaccessible to an unauthorized person. Consequently, a discrepancy would be detected in the step 54 between the position of the transponder determined by the TCAS-type anticollision system and the theoretical position of the transponder 38. The environmental data received therefore would not be authenticated.

In a step 55, only implemented if the environmental data received have been authenticated in the step 54, the flight management system 14 orders an aircraft flight trajectory as a function of at least one item of the environmental information received. The trajectory thus ordered is transmitted to the aircraft guidance system 15, for example.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for assisting a landing of an aircraft at an airport, the system comprising:
an aircraft flight management system and a TCAS-type anticollision system which are both installed on board the aircraft;
a transponder installed in a predefined position at the airport, the transponder being linked to a computer of an air traffic control center of the airport;
the transponder being configured to receive and save, in a memory, environmental information transmitted by the computer of the air traffic control center of the airport;
the TCAS-type anticollision system being configured to interrogate the transponder and to receive, in response, the environmental information saved in the memory of the transponder, and to determine a position of the transponder;
at least one of the TCAS-type anticollision system or the aircraft flight management system being configured to compare the position of the transponder determined by the TCAS-type anticollision system with a theoretical position of the transponder saved in a database on board the aircraft to determine whether the position of the transponder determined by the TCAS-type anticollision system corresponds to the theoretical position of the transponder and to authenticate the environmental information received from the transponder only if the position of the transponder determined by the TCAS-type anticollision system corresponds to the theoretical position of the transponder; and
the flight management system being configured such that, in an event that the environmental information received from the transponder is authenticated, the flight management system orders an aircraft flight trajectory as a function of at least the environmental information.

2. The system of claim 1, wherein the environmental information comprises at least one subset of environmental information of:
meteorological information;
information relating to a landing runway of the airport;
information relating to the airport.

3. The system of claim 1, wherein the transponder is linked to the computer of the air traffic control center of the airport via a communication link which is independent of a public communication network.

4. An aircraft having a system for assisting landing at an airport, the system comprising:
an aircraft flight management system and a TCAS-type anticollision system;
the TCAS-type anticollision system being configured to:
interrogate a transponder installed in a predefined position at the airport, the transponder being linked to a computer of an air traffic control center of the airport and being configured to receive and save, in a memory, environmental information transmitted by the computer of the air traffic control center of the airport;
receive, in response, the environmental information saved in the memory of the transponder; and
determine a position of the transponder;
at least one of the TCAS-type anticollision system or the aircraft flight management system being configured to compare the position of the transponder determined by the TCAS-type anticollision system with a theoretical position of the transponder saved in a database on board the aircraft to determine whether the position of the transponder determined by the TCAS-type anticollision system corresponds to the theoretical position of the transponder and to authenticate the environmental information received from the transponder only if the position of the transponder determined by the TCAS-type anticollision system corresponds to the theoretical position of the transponder; and
the flight management system being configured such that, in an event that the environmental information received from the transponder is authenticated, the flight management system orders an aircraft flight trajectory as a function of at least the environmental information.

5. A method for assisting a landing of an aircraft at an airport, the aircraft comprising a flight management system and a TCAS-type anticollision system which are installed on board the aircraft, a transponder being installed in a predefined position at the airport, the transponder being linked to a computer of an air traffic control center of the airport, wherein the method comprises:
a step implemented by the computer of the air traffic control center of the airport of transmitting environmental information, relating to the airport, to the transponder;
a step implemented by the transponder of receiving the environmental information and in saving it in a memory;
a step implemented by the TCAS-type anticollision system of interrogating the transponder, and receiving, in response, the environmental information saved in the memory of the transponder, and determining a position of the transponder;
a step implemented by at least one of the TCAS-type anticollision system or the aircraft flight management system of comparing the position of the transponder determined by the TCAS-type anticollision system with a theoretical position of the transponder saved in a database on board the aircraft to determine whether the position of the transponder determined by the TCAS-type anticollision system corresponds to the theoretical position of the transponder and authenticating the environmental information received from the transponder only if the position of the transponder determined by the TCAS-type anticollision system corresponds to the theoretical position of the transponder; and
in an event that the environmental information received from the transponder is authenticated, a step implemented by the flight management system of ordering an aircraft flight trajectory as a function of at least the environmental information.
